(19) United States
(12) Patent Application Publication
(10) Pub. No.: US 2023/0281629 A1
(43) Pub. Date: Sep. 7, 2023

(54) UTILIZING A CHECK-RETURN PREDICTION MACHINE-LEARNING MODEL TO INTELLIGENTLY GENERATE CHECK-RETURN PREDICTIONS FOR NETWORK TRANSACTIONS

(71) Applicant: Chime Financial, Inc., San Francisco, CA (US)

(72) Inventors: Nik Shevyrev, San Mateo, CA (US); Peeyush Agarwal, Mountain View, CA (US); Jiby Babu, Leander, TX (US)

(21) Appl. No.: 17/653,580

(22) Filed: Mar. 4, 2022

(51) Int. Cl. G06Q 20/40; G06Q 40/02

(52) U.S. Cl. CPC G06Q 20/4016; G06Q 40/02

(57) ABSTRACT

The present disclosure relates to systems, non-transitory computer-readable media, and methods that utilize a check-return machine-learning model to predict whether a mobile check deposit will result in a check-return (e.g., due to mobile check deposit fraud). For instance, the disclosed systems can receive a request to initiate a mobile check deposit. In response to the request, the disclosed systems identify one or more features associated with the mobile check deposit. For example, the one or more features may include check features, historical returned and posted checks for a check maker account, recipient account historical data, or recipient account payment schedule data, etc. From the one or more features, the check-return machine-learning model generates a check-return prediction. In turn, the disclosed systems utilize the check-return prediction to process the mobile check deposit.

### BACKGROUND

As online transactions have increased in recent years, network-transaction-security systems have increasingly used computational models to detect and protect against cyber fraud, cyber theft, or other network security threats that compromise encrypted or otherwise sensitive information. For example, as network security risks have increased, existing network-transaction-security systems have employed more sophisticated computing models to detect security risks affecting transactions, account balances, personal identity information, and other information over computer networks that use computing device applications. In mobile check deposit network transactions, for instance, these security risks can take the form of fake check images, repeat mobile deposit attempts for a singular check via different account systems, synthetic network accounts, altered or forged check data, etc. Exacerbating these issues, hackers have become more sophisticated—in some cases to the point of mimicking the characteristics of authentic network transactions detected or flagged by existing computational models.

In view of the foregoing complexities, conventional network-transaction-security systems have proven inaccurate—often misidentifying returned checks or failing to detect returned checks until too late. Indeed, conventional network-transaction-security systems often fail to intelligently differentiate between true positive and false positive fraudulent mobile check deposit network transactions. For instance, because hackers try to simulate the features of an authorized or legitimate transaction, computing systems that apply rigid computing models (e.g., heuristics) often cannot detect the difference between fraudulent and non-fraudulent features for mobile check deposits.

Similarly, these conventional computing models cannot consistently identify returned checks as corresponding to one class of mobile check deposit fraud versus another class of mobile check deposit fraud. To illustrate, conventional computing models cannot accurately differentiate data signals for a fraudulent mobile check deposit. Without more granular identification capabilities, conventional network-transaction-security systems perpetuate inaccuracies of check-return identification (e.g., as evident by false negative and/or false positive mobile check deposit fraud values).

### BRIEF SUMMARY

This disclosure describes embodiments of systems, non-transitory computer-readable media, and methods that solve one or more of the foregoing problems in the art or provide other benefits described herein. In particular, the disclosed systems utilize a check-return machine-learning model to predict whether a mobile check deposit network transaction will result in a check-return (e.g., due to mobile check deposit fraud). For instance, the disclosed systems can receive a request to initiate a network transaction comprising a mobile check deposit. In response to the request, the disclosed systems identify one or more features associated with the network transaction. For example, the one or more features may include check features, historical returned and posted checks for a check maker account, recipient account historical data, or recipient account payment schedule data, etc. From the one or more features, the check-return machine-learning model generates a check-return prediction. To illustrate, the disclosed systems can implement an XGBoost machine-learning model to generate a binary check-return prediction or a check-return prediction score based on one or more weighted features.

Based on the check-return prediction, the disclosed systems can process the network transaction. For example, the disclosed systems can approve the network transaction based on a check-return prediction score satisfying a first threshold check-return prediction score. As another example, the disclosed systems can suspend the network transaction based on a check-return prediction score satisfying a second threshold check-return prediction score. In yet another example, the disclosed systems can deny the network transaction based on a check-return prediction score satisfying a third threshold check-return prediction score.

By utilizing a check-return machine-learning model, the disclosed systems can improve the accuracy of detecting or predicting fraudulent mobile check deposits that will result in a check-return. As described further below, the disclosed systems can accordingly improve the speed and computing efficiency of detecting fraudulent mobile check deposits over existing network-transaction-security systems. In some cases, such a check-return machine-learning model can find feature patterns (or fraudulent data signatures) that existing network-transaction-security systems cannot detect.

### BRIEF DESCRIPTION OF THE DRAWINGS

The detailed description provides one or more embodiments with additional specificity and detail through the use of the accompanying drawings, as briefly described below.

FIG. 1 illustrates a computing system environment for implementing a mobile check deposit system in accordance with one or more embodiments.

FIG. 2 illustrates a mobile check deposit system utilizing a check-return machine-learning model to generate a check-return prediction for a network transaction in accordance with one or more embodiments.

FIG. 3 illustrates a mobile check deposit system generating a check-return prediction and performing one or more corresponding digital actions in accordance with one or more embodiments.

FIG. 4 illustrates a mobile check deposit system training a check-return machine-learning model in accordance with one or more embodiments.

FIGS. 5A-5B illustrate examples of different check-return prediction scores in accordance with one or more embodiments.

FIGS. 6A-6C illustrate graphs depicting an accuracy of a mobile check deposit system generating check-return predictions using a check-return machine-learning model in accordance with one or more embodiments.

FIG. 7 illustrates a flowchart of a series of acts for utilizing a check-return machine-learning model to generate a check-return prediction for a network transaction in accordance with one or more embodiments.

FIG. 8 illustrates a block diagram of an example computing device for implementing one or more embodiments of the present disclosure.

FIG. 9 illustrates an example environment for an inter-network facilitation system in accordance with one or more embodiments.

### DETAILED DESCRIPTION

This disclosure describes one or more embodiments of a mobile check deposit system that in real time (or near real time) predicts whether an initiated network transaction (e.g., mobile check deposit) is fraudulent based on a machine-learning model that intelligently weights features associated with the network transaction. For example, in less than a hundred millisecond latency, the mobile check deposit system can determine a mobile check deposit is fraudulent from image-based check data, network account data, historical transactions, and other features. For instance, in one or more embodiments, the mobile check deposit system uses features such as an entered amount on the check, a number of posted checks by the check maker, an average account balance of the check maker, a number of ATM machine uses, etc. to determine whether a given mobile check deposit will likely result in a check-return. Moreover, by utilizing a machine-learning model to analyze these and other features, the mobile check deposit system can intelligently adapt to new fraud schemes, changes to fraud behavior, etc. Accordingly, in some embodiments, the mobile check deposit system identifies one or more features associated with the network transaction, for example, historical returned and posted checks for a check maker account, recipient account historical data, or recipient account payment schedule data.

Based on the one or more features, the mobile check deposit system uses a check-return machine-learning model to generate a binary check-return prediction, a check-return prediction score, or other prediction or recommendation. In some embodiments, the check-return machine-learning model generates a check-return prediction indicating a mobile check deposit is (or is likely to) result in a returned check. In particular embodiments, the check-return machine-learning model generates a check-return prediction indicating a probability that the mobile check deposit corresponds to a certain class of mobile check deposit fraud (e.g., altered checks, forged checks, duplicate checks, etc.).

Based on the check-return prediction, the mobile check deposit system can process the network transaction. For instance, the mobile check deposit system can approve, deny, or suspend the network transaction based on the check-return prediction. To illustrate, the mobile check deposit system can auto-approve (e.g., accept) or auto-deny (e.g., reject) the mobile check deposit based on the check-return prediction. Alternatively, in one or more embodiments, the mobile check deposit system suspends the mobile check deposit based on the check-return prediction.

For example, the mobile check deposit system may approve a fractional amount of the mobile check deposit amount to issue to a recipient network account. The mobile check deposit system further suspends the remainder of the mobile check deposit amount from account issuance until the mobile check deposit is validated (e.g., verified, posted, or the check-return prediction is updated to indicate a likelihood of non-return). Still, in other embodiments, the mobile check deposit system suspends an entire amount of the mobile check deposit amount until the mobile check deposit is validated.

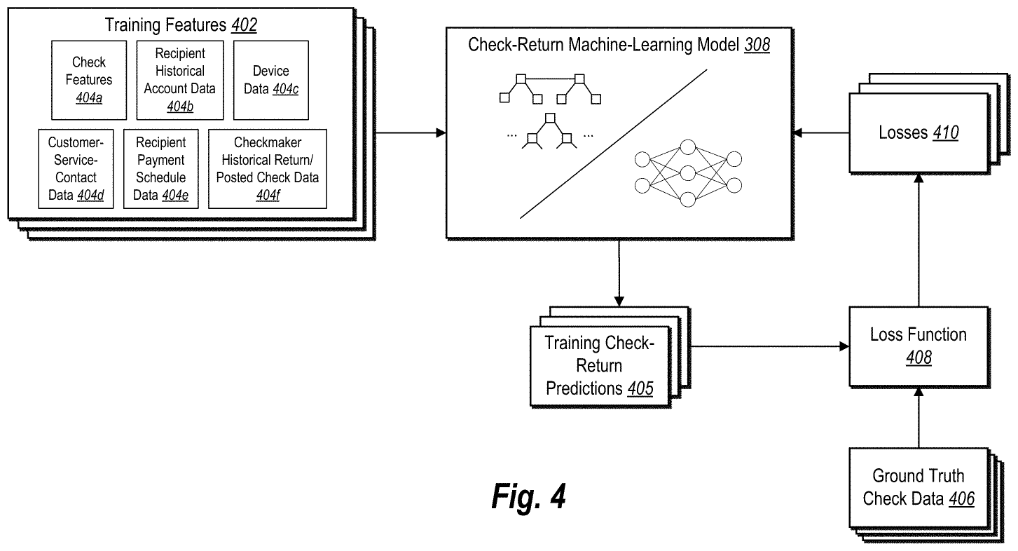

In some embodiments, the mobile check deposit system trains the check-return machine-learning model utilizing one or more different approaches. In particular embodiments, the mobile check deposit system trains the check-return machine-learning model (e.g., an XGBoost machine-learning model) by comparing training check-return predictions and ground truth check-return data. As will be described below in relation to FIG. 4, ground truth check-return data can include a variety of different labels for observed or real data, such as posted check data, rejected check data, returned checks, etc. In this manner, the mobile check deposit system can dynamically learn changes in mobile check deposit fraud and improve model accuracy of check-return predictions.

As mentioned above, the mobile check deposit system can provide a number of technical advantages over conventional network-transaction-security systems. For example, the mobile check deposit system can improve accuracy of check-return predictions and, therefore, improve network security. To illustrate, the mobile check deposit system uses a check-return machine-learning model that generates more accurate check-return predictions for network transactions than existing network-transaction-security systems. By using a unique combination of features associated with a network transaction, the mobile check deposit system trains (or uses a trained version of) a check-return machine-learning model to generate finely tuned predictions of whether such initiated mobile check deposits will result in a check-return. In some cases, the mobile check deposit system identifies (and uses) a particular set of transaction features that— when combined and weighted according to learned parameters—constitute a digital marker or fraud fingerprint to accurately predict whether a mobile check deposit is fraudulent or legitimate.

In addition to improved accuracy and network security, the mobile check deposit system can also improve system speed and efficiency of determining an authenticity or legitimacy of an initiated mobile check deposit network transaction. For example, the mobile check deposit system can intelligently differentiate between authentic and fraudulent mobile check deposit network transactions by utilizing a check-return machine-learning model trained on a particular combination of weighted features for mobile check deposits. Uniquely trained with such combinations and learned feature weightings, the check-return machine-learning model can detect fraudulent action in real time (or near-real time) without processing multiple transactions of a serial fraudster or other target account.

That is, the mobile check deposit system need not identify multiple instances of suspicious mobile check deposits before predicting a mobile check deposit will likely result in a check-return. Rather, the mobile check deposit system can identify first instances of mobile check deposit fraud based on particular combinations of check features, historical returned and posted checks for a check maker account, recipient account historical data, recipient account payment schedule data, etc. In addition, the mobile check deposit system can, within milliseconds, determine whether a mobile check deposit is fraud and either approve, deny, or suspend the network transaction. If suspended, the mobile check deposit system can then, without undue back-and-forth digital communications, quickly validate a mobile check deposit and either approve the mobile check deposit or deny the mobile check deposit. Alternatively, if suspended, the mobile check deposit system can flexibly tailor validation actions based on a check-return prediction. For instance, the mobile check deposit system can (i) approve (e.g., immediately) a fractional amount of a mobile check deposit amount based on the check-return prediction and (ii) suspend a remainder amount of the mobile check deposit amount until the mobile check deposit is validated.

As illustrated by the foregoing discussion, the present disclosure utilizes a variety of terms to describe features and benefits of mobile check deposit system. Additional detail is now provided regarding the meaning of these terms. For example, as used herein, the term “network transaction” refers to a transaction performed as part of a digital exchange of funds, tokens, currency, or data between accounts or other connections of a computing system. In particular embodiments, the network transaction can be a mobile check deposit (e.g., a digital request for executing a check that can transfer funds from a check maker account to a recipient account). Indeed, a network transaction that is a mobile check deposit can be implemented via a variety of client devices. In some embodiments, the network transaction may be a transaction with a merchant (e.g., a purchase transaction) in which a merchant or payee indicated on a check corresponds to the recipient account.

In addition, the term “network account” refers to a computer environment or location with personalized digital access to a web application, a native application installed on a client device (e.g., a mobile application, a desktop application, a plug-in application, etc.), or a cloud-based application. In particular embodiments, a network account includes a financial payment account through which a user can initiate a network transaction (e.g., a mobile check deposit) on a client device or with which another user can exchange tokens, currency, or data. Examples of a network account include a CHIME® account. In addition, network accounts can be delineated by check maker account and recipient account on a per-transaction basis. Relatedly, a “check maker account” refers to a network account that is designated to send or provide funds, tokens, currency, or data in a mobile check deposit network transaction. In addition, a “recipient account” refers to a network account designated to receive funds, tokens, currency, or data in mobile check deposit network transaction.

As also used herein, the term “feature” refers to characteristics or attributes related to a network transaction. In particular embodiments, a feature includes account-based characteristics associated with a check maker account or recipient account corresponding to a mobile check deposit network transaction. Still further, a feature can include transaction-based details of one or more network transactions. This disclosure describes additional examples of features below.

As used herein, the term “check-return machine-learning model” refers to a machine-learning model trained or used to identify illegitimate network transactions. In some cases, a check-return machine-learning model refers to a trained machine-learning model that generates a check-return prediction for one or more mobile check deposits. For example, a check-return machine-learning model can include a random forest model, a series of gradient boosted decision trees (e.g., XGBoost algorithm), a multilayer perceptron, a linear regression, a support vector machine, a deep tabular learning architecture, a deep learning transformer (e.g., self-attention-based-tabular transformer), or a logistic regression. In other embodiments, a check-return machine-learning model includes a neural network, such as a convolutional neural network, a recurrent neural network (e.g., an LSTM), a graph neural network, a self-attention transformer neural network, or a generative adversarial neural network.

Additionally, as used herein, the term “check-return prediction” refers to a classification or metric indicating whether a mobile check deposit is illegitimate and will therefore result in a check-return. In some embodiments, a check-return prediction comprises a binary value indicating whether a check will be returned, such as a “0” or a “1” or a “yes” or “no,” indicating a mobile check deposit will or will not likely result in a check-return. In other embodiments, a check-return prediction can comprise a check-return prediction score (e.g., a number, probability value, or other numerical indicator) indicating a degree or likelihood that a check-return machine-learning model predicts a mobile check deposit will result in a check-return. In certain implementations, a check-return prediction indicates a classification, score, and/or probability for various types or classes of mobile check deposit fraud (e.g., altered checks, forged checks, duplicate checks, etc.).

Relatedly, as used herein, the term “check-return” refers to network state or transaction status in which funds are unauthorized for transfer from a check-maker account (or cannot be transferred from the check maker account after one or more attempts) in response to a mobile check deposit. For example, identifying that a check maker account is false (e.g., synthetic) can trigger a check-return. As another example, identifying insufficient funds in a check maker account can trigger a check-return. In yet another example, identifying a disputed or unauthorized check (e.g., a stolen/forged check) that the account holder corresponding to the check maker account did not authorize to be executed can trigger a check-return.

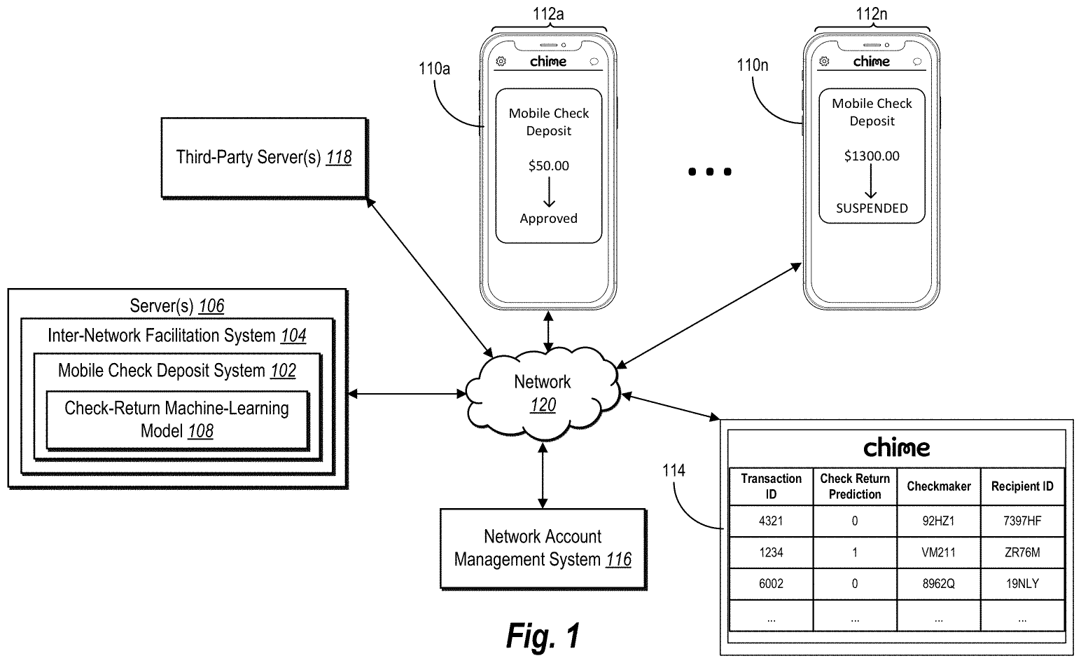

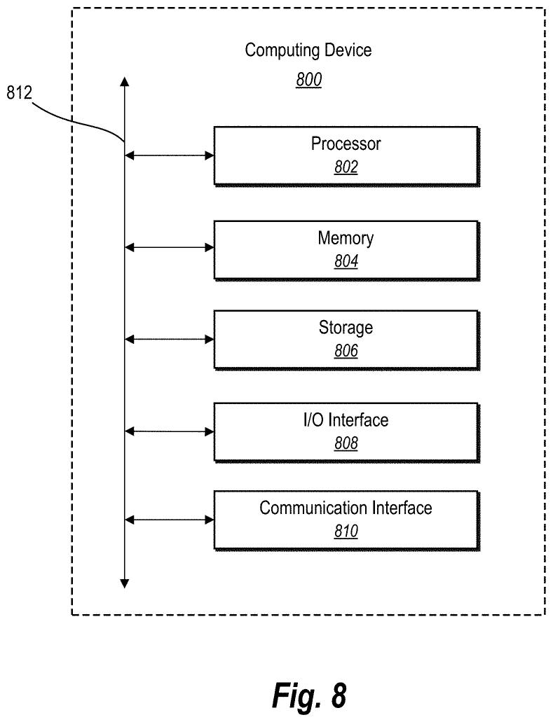

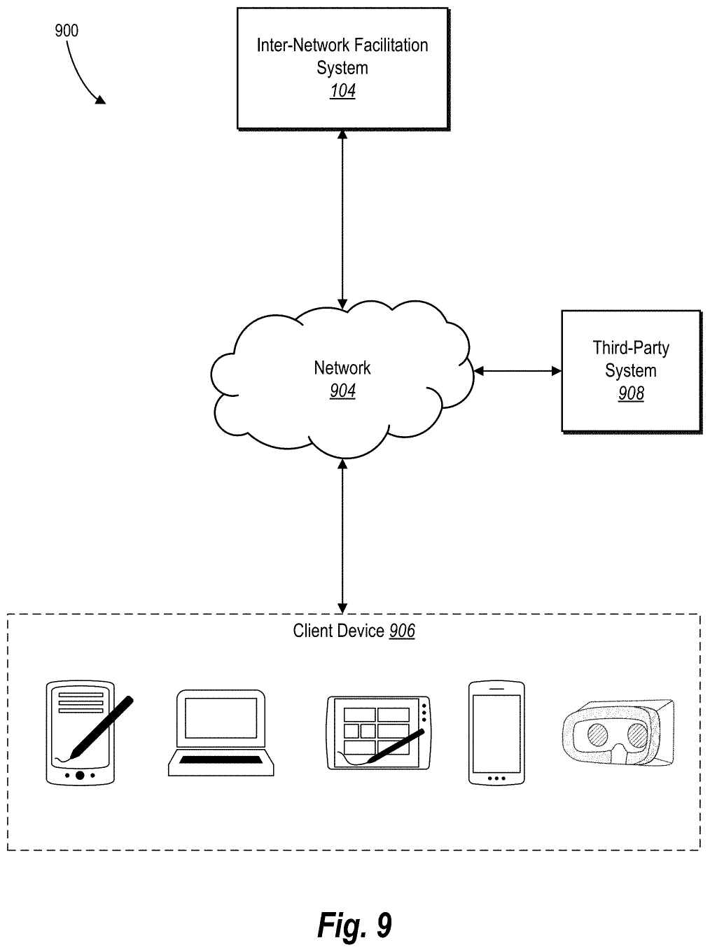

Additional detail regarding the mobile check deposit system will now be provided with reference to the figures. In particular, FIG. 1 illustrates a computing system environment for implementing a mobile check deposit system 102 in accordance with one or more embodiments. As shown in FIG. 1, the environment includes server(s) 106, client device(s) 110a-110n, an administrator device 114, a network account management system 116, and third-party server(s) 118. Each of the components of the environment 100 communicate (or are at least configured to communicate) via a network 120, and the network 120 may be any suitable network over which computing devices can communicate. Example networks are discussed in more detail below in relation to FIGS. 8-9.

As further illustrated in FIG. 1, the environment 100 includes the server(s) 106. In some embodiments, the server(s) 106 comprises a content server and/or a data collection server. Additionally or alternatively, the server(s) 106 comprise an application server, a communication server, a web-hosting server, a social networking server, a digital content management server, or a financial payment server.

Moreover, as shown in FIG. 1, the server(s) 106 implement an inter-network facilitation system 104. In one or more embodiments, the inter-network facilitation system 104 (or the mobile check deposit system 102) communicates with the client device(s) 110a-110(n) to identify accounts associated with a network transaction. More specifically, the inter-network facilitation system 104 (or the mobile check deposit system 102) can communicate with one or more of the client devices 110a-110n to request a digital image of a check, indicate an approved, denied, or suspended network transaction, etc.

As additionally shown in FIG. 1, the mobile check deposit system 102 implements a check-return machine-learning model 108. The check-return machine-learning model 108 generates check-return predictions corresponding to network transactions. Specifically, the check-return machine-learning model 108 generates a check-return prediction for a mobile check deposit based on one or more features corresponding to the mobile check deposit. Based on the check-return prediction, the mobile check deposit system 102 can process the mobile check deposit.

Further, the environment 100 includes the client devices 110a-110n. The client devices 110a-110n can include one of a variety of computing devices, including a smartphone, tablet, smart television, desktop computer, laptop computer, virtual reality device, augmented reality device, or other computing device as described in relation to FIGS. 8-9. Although FIG. 1 illustrates only two client devices, the environment 100 can include many different client devices connected to each other via the network 120 (e.g., as denoted by the separating ellipses). Further, in some embodiments, the client devices 110a-110n receive user input and provide information pertaining to accessing, viewing, modifying, generating, and/or initiating a network transaction to the server(s) 106.

Moreover, as shown, the client devices 110a-110n include corresponding client applications 112a-112n. The client applications 112a-112n can each include a web application, a native application installed on the client devices 110a-110n (e.g., a mobile application, a desktop application, a plug-in application, etc.), or a cloud-based application where part of the functionality is performed by the server(s) 106. In some embodiments, the mobile check deposit system 102 causes the client applications 112a-112n to present or display information to a user associated with the client devices 110a-110n, including information relating to mobile check deposits as provided in this disclosure.

The mobile check deposit system 102 can also communicate with the administrator device 114 to provide information relating to a check-return prediction. In some embodiments, the mobile check deposit system 102 causes the administrator device 114 to display, on a per-transaction basis, whether a network transaction between a check maker account and a recipient account has triggered (or will likely trigger) a check-return. Additionally or alternatively, the mobile check deposit system 102 can graphically flag certain mobile check deposits (e.g., via a visual indicator) for a certain class or type of check-return prediction within a graphical user interface on the administrator device 114.

In addition, the mobile check deposit system 102 can communicate with the network account management system 116 regarding one or more network transactions. For example, the mobile check deposit system 102 can communicate with the network account management system 116 to identify one or more of transaction data, network account data, device data corresponding to the client devices 110a-110n, etc.

In a same or similar manner, the mobile check deposit system 102 can communicate with the third-party server(s) 118. For instance, the mobile check deposit system 102 can communicate with the third-party server(s) 118 to extract and/or verify one or more of transaction data, network account data, device data corresponding to the client devices 110a-110n, etc. To illustrate, in certain implementations, the mobile check deposit system 102 uses the third-party server(s) 118 (e.g., GIACT® servers) to extract and verify magnetic ink character recognition data from a check image corresponding to a mobile check deposit.

In some embodiments, though not illustrated in FIG. 1, the environment 100 has a different arrangement of components and/or has a different number or set of components altogether. For example, in certain embodiments, the client devices 110a-110n communicate directly with the server(s) 106, bypassing the network 120. As another example, the environment 100 omits one or more components, such as the third-party server(s) 118. In yet another example, one or more different components implement the inter-network facilitation system 104. Likewise, in certain implementations, additional or alternative components implement the mobile check deposit system 102 to facilitate different component arrangements than illustrated in FIG. 1.

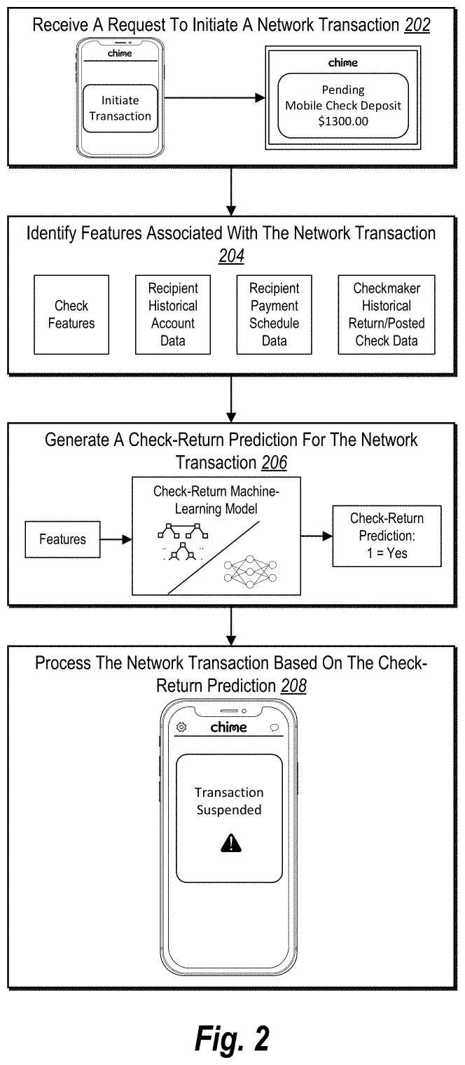

As mentioned above, the mobile check deposit system 102 can efficiently and accurately generate a check-return prediction. In accordance with one or more embodiments, FIG. 2 illustrates the mobile check deposit system 102 utilizing a check-return machine-learning model to generate a check-return prediction for an initiated network transaction based on features associated with the network transaction.

At an act 202 in FIG. 2, for example, the mobile check deposit system 102 receives a request to initiate a network transaction. In particular embodiments, the act 202 comprises identifying, from a recipient account, a transaction request for executing a mobile check deposit. For instance, the act 202 comprises identifying, in real time (or near real time), an indication of a user input via a client application confirming a request to initiate a mobile check deposit. In particular embodiments, the act 202 comprises receiving an image of a check indicating a transfer of funds from a check maker account to the recipient account.

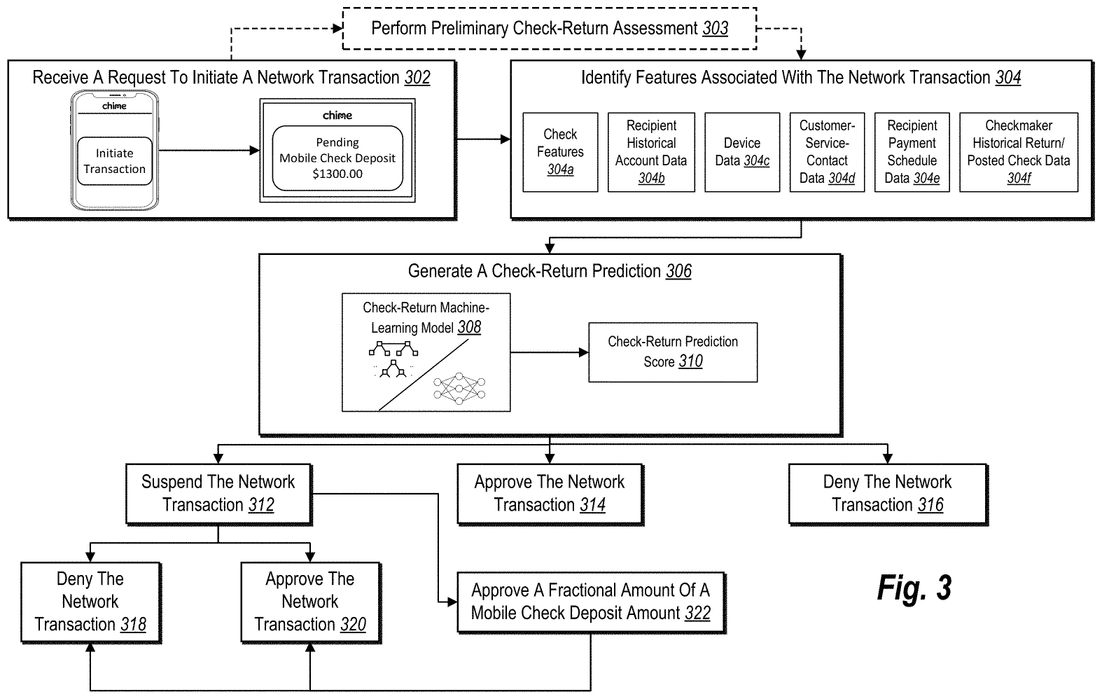

At an act 204, the mobile check deposit system 102 identifies features associated with the network transaction. In particular embodiments, the mobile check deposit system 102 responds to the request for initiating the network transaction (e.g., a mobile check deposit) by extracting or identifying check features from a check image. Additionally or alternatively, the mobile check deposit system 102 identifies recipient historical account data, recipient payment schedule data, check maker historical return/posted check data, etc. In certain implementations, the mobile check deposit system 102 utilizes one or more third-party servers to identify features associated with a mobile check deposit and/or provide a preliminary check-return assessment. These features and associated acts are described in more detail below in relation to FIG. 3.

At an act 206 shown in FIG. 2, the mobile check deposit system 102 utilizes a check-return machine-learning model to generate a check-return prediction for the network transaction. In particular, from the identified features associated with the network transaction, the mobile check deposit system 102 uses the check-return machine-learning model to generate a check-return prediction. As shown at the act 206, the check-return prediction provides a binary value (“1=Yes”) to indicate that the network transaction will likely trigger or result in a check-return. In other embodiments, however, the check-return machine-learning model generates a check-return prediction score (e.g., a non-binary value) that more precisely indicates how likely the network transaction will trigger or result in a check-return. Further, in some embodiments, the check-return machine-learning model generates a check-return prediction indicating a classification, score, and/or probability for various types or classes of mobile check deposit fraud (e.g., altered checks, forged checks, duplicate checks, etc.).

At an act 208, the mobile check deposit system 102 processes the network transaction based on the check-return prediction. For example, based on the check-return prediction being “1=Yes,” the mobile check deposit system 102 suspends the network transaction by at least temporarily disallowing transfer of the requested funds according to the initiated mobile check deposit. In certain implementations, the mobile check deposit system 102 outright denies the network transaction based on the check-return prediction. In contrast, if the check-return prediction is “0=No,” the mobile check deposit system 102 approves the network transaction and allows the mobile check deposit to proceed to completion.

It will be appreciated that the mobile check deposit system 102 can perform additional or alternative acts based on the check-return prediction. For example, in one or more embodiments, the mobile check deposit system 102 uses feature scores from the check-return machine-learning model to generate a recommendation or graphical indicator for display on an administrator device. Such a recommendation or graphical indicator can flag one or more features associated with the mobile check deposit as suspicious of fraud or otherwise indicative of a potential check-return.

As mentioned above, the mobile check deposit system 102 utilizes a check-return machine-learning model to generate a check-return prediction. Based on the check-return prediction, the mobile check deposit system 102 can perform various responsive actions. For example, the mobile check deposit system 102 can suspend a network transaction, approve the network transaction, or deny the network transaction. In accordance with one or more such embodiments, FIG. 3 illustrates the mobile check deposit system 102 generating a check-return prediction and performing one or more corresponding digital actions.

At an act 302, for example, the mobile check deposit system 102 receives a request to initiate a network transaction. The act 302 is the same as or similar to the act 202 described above in relation to FIG. 2. For example, the mobile check deposit system 102 identifies one or more user interactions within a client application logged into a network account to submit a network transaction. For example, the mobile check deposit system 102 may identify swipe interactions, button presses, taps, etc. in relation to one or more user interface elements configured to initiate a network transaction. For a mobile check deposit, the mobile check deposit system 102 may receive a check image (e.g., uploaded images or live-capture images via a device viewfinder) portraying a check.

At an optional act 303, the mobile check deposit system 102 performs (or causes third-party server(s) to perform) a preliminary check-return assessment. In one or more embodiments, the act 303 comprises verifying or assessing certain features associated with the requested network transaction. For example, the act 303 comprises verifying accounts associated with the network transaction are valid and open (e.g., active). As further examples, the act 303 comprises validating a routing number or check number, identifying account history, cross-checking institutional blacklists, etc.

In certain implementations, the mobile check deposit system 102 transmits the check image (and/or scraped image data) to GIACT® servers, which performs such a preliminary check-return assessment based on image extracted from the check image. In turn, the mobile check deposit system 102 proceeds with the act 304 if the preliminary check-return assessment indicates one or more predetermined positive or safe response codes (e.g., “_1111” for account verified).

Otherwise, for predetermined negative or risky sentiment response codes (e.g., “GN05” for non-assigned routing number or “bad check history=TRUE”), the mobile check deposit system 102 automatically denies the network transaction before proceeding further to subsequent acts shown in FIG. 3. As another example, the mobile check deposit system 102 auto-denies a network transaction if a detected check velocity (e.g., a number of discrete mobile check deposit events in a single day) satisfies a threshold velocity, such as greater than or equal to four. In yet another example, the mobile check deposit system 102 auto-denies a network transaction if a check's entered amount is over a threshold amount (e.g., $3000 USD).

In one or more embodiments, the mobile check deposit system 102 generates a data structure (e.g., a digital table stored in a memory device) comprising features associated with prior network transactions and network account data for a plurality of network accounts. In particular embodiments, the mobile check deposit system 102 (or third-party server(s)) updates the data structure with information based on the preliminary check-return assessment. For example, the mobile check deposit system 102 populates one or more fields of the data structure with entries corresponding to preliminary check-return assessment data provided by GIACT® servers.

At an act 304, the mobile check deposit system 102 identifies features associated with the network transaction. In certain implementations, identifying the features associated with the network transaction comprises accessing the data structure discussed above. For example, the mobile check deposit system 102 executes one or more search queries to retrieve entries corresponding to predetermined rows, columns, or fields defining features identified in the preliminary check-return assessment.

In particular embodiments, the mobile check deposit system 102 identifies at least one of check features 304a, recipient historical account data 304b, device data 304c, customer-service-contact data 304d, recipient payment schedule data 304e, or check maker historical return/posted check data 304f. The following paragraphs briefly describe and give examples of such features.

In one or more embodiments, the check features 304a includes elements associated with the check portrayed in the check image for a mobile check deposit. For example, the check features 304a may include an identifier or name (e.g., the issuer or payer) associated with a check maker account or a payee name corresponding to the recipient account. In addition, the check features 304a include a deposit date, the issuing bank, MICR data (e.g., routing number, check number, checking account number), issuer signature, entered amount (numerical and/or written), issue date, void date, endorsement signature, endorsement restriction (e.g., “for mobile deposit at Chime only”), etc.

In one or more embodiments, the check features 304a also include analyzed or predicted data (e.g., based on image analysis, signature analysis, etc.). For example, the check features 304a include identified indications of alterations, mismatching of check fields, prohibited check types (e.g., money orders or balance transfer), a deposit date past the void date, a suspicious signature, etc.

In addition, the recipient historical account data 304b may include historical information for a recipient account of a predetermined period of time preceding the requested network transaction (e.g., minutes, hours, days, weeks, months, and years prior). Examples of the recipient historical account data 304b include average balance, a direct deposit count, an ATM use count, an interchange count with the check maker account, an account maturity (or account age since enrollment), etc.

Further, the device data 304c may include device-specific information for a check maker device and recipient device. In particular embodiments, the device data 304c includes an IP address at predetermined times (e.g., at the time of requested transaction, one day prior, one week prior, one month prior). In some embodiments, the device data 304c includes position data, such as global positioning system data, address, city/state information, zip code, time-zone, etc. Additionally or alternatively, the device data 304c includes an operating system identifier, device manufacturer, device identifier (e.g., serial number), device carrier information, or a type of device (e.g., mobile device, tablet, desktop computer).

The customer-service-contact data 304d includes various details regarding interactions between a network account and customer service of a network account management system. In one or more embodiments, the customer-service-contact data 304d includes fraud claims, help requests, complaints, disputes, etc. In certain implementations, the customer-service-contact data 304d includes frequency of contact, form of contact (e.g., chat versus phone call), customer rating, date and time of recent customer service contact, etc.

The recipient payment schedule data 304e includes payday information, such as a day of the week scheduled for direct deposits. In addition, for example, the recipient payment schedule data 304e includes bill payments scheduled to issue and/or a number of prior-completed direct deposits.

The check maker historical return/posted check data 304f includes information about previous checks and account data for a check maker account. In some embodiments, the check maker historical return/posted check data 304f includes a number of posted checks, a total transaction amount for posted checks, a number of returned checks (e.g., checks triggering a check-return), an average transaction amount for returned checks, a number of rejected checks (e.g., checks prevented from being transacted), a total transaction amount for rejected checks, an average check maker account balance, etc.

As further shown in FIG. 3, at an act 306, the mobile check deposit system 102 generates a check-return prediction utilizing a check-return machine-learning model 308. In particular embodiments, the check-return machine-learning model 308 analyzes one or more of the features identified at the act 304 described above. Additionally or alternatively, the check-return machine-learning model 308 analyzes one or more of the features indicated in Table 1 described below.

In one or more embodiments, the check-return machine-learning model 308 utilizes one or more different approaches to analyzing features associated with the requested network transaction. In certain implementations, however, the check-return machine-learning model 308 analyzes the features associated with a network transaction according to a feature importance scheme or feature weighting. Additionally or alternatively, the check-return machine-learning model 308 uses various parameters. For instance, in one or more embodiments, the check-return machine-learning model 308 comprises an XGBoost machine-learning model.

Based on analyzing the features associated with the network transaction, the check-return machine-learning model 308 generates a check-return prediction. As described above in relation to FIG. 2, the check-return prediction can include a binary value (e.g., “1=Yes”) to indicate that the network transaction will likely trigger a check-return. In other embodiments, however, the check-return machine-learning model 308 generates a check-return prediction score 310 (e.g., a non-binary value) that more precisely indicates how likely the network transaction will trigger a check-return. In particular embodiments, the check-return machine-learning model 308 generates the check-return prediction score 310 composed of or based on feature scores (e.g., that indicate particular check-return scores for different features identified at the act 304). For instance, the check-return prediction score 310 may include an aggregate of the feature scores. Additionally or alternatively, the check-return prediction score 310 may include multiple check-return prediction scores (e.g., for multiple types or classes of mobile check deposit fraud (e.g., an altered check score, a forged check score, a duplicate check score, etc.).

To illustrate one particular embodiment implementing the XGBoost architecture, the check-return machine-learning model 308 weights one or more of the identified features from the act 304 in at least two decision trees arranged in series. Additionally, the check-return machine-learning model 308 generates a first check-return prediction utilizing a first decision tree. The check-return machine-learning model 308 then generates a second check-return prediction utilizing a second decision tree based on the first check-return prediction, and so forth until generating a final check-return prediction (e.g., the check-return prediction score 310). In this model version, the check-return machine-learning model 308 comprises various hyper parameters, such as learning_rate: 0.1, n_estimators: 150, max_depth: 4, gamma: 1.

Based on the check-return prediction, the mobile check deposit system 102 performs various acts. For example, the mobile check deposit system 102 performs one of acts 312-316. To illustrate, in certain implementations, the mobile check deposit system 102 performs the act 314 based on a low check-return prediction score indicating a low-risk or low probability of a check-return. In contrast, the mobile check deposit system 102 can perform the act 316 based on a high check-return prediction score indicating a high-risk or high probability of a check-return. Alternatively, the mobile check deposit system 102 can perform the act 312 based on a medium check-return prediction score indicating a medium-risk or medium probability of a check-return.

It will be appreciated that performing one of the acts 312-316 is based on the check-return prediction score 310 satisfying (e.g., exceeding, comporting with, falling under, or being within a predetermined percentage of) one or more threshold prediction scores or threshold prediction score ranges. For example, in one or more embodiments, the mobile check deposit system 102 approves the network transaction based on the check-return prediction score 310 satisfying a first threshold check-return prediction score. As another example, the mobile check deposit system 102 suspends the network transaction based on the check-return prediction score 310 satisfying a second threshold check-return prediction score. In yet another example, the mobile check deposit system 102 denies the network transaction based on the check-return prediction score 310 satisfying a third threshold check-return prediction score.

In more detail, at an act 312, the mobile check deposit system 102 suspends the network transaction by temporarily stopping the transfer of funds to a recipient account. That is, the mobile check deposit system 102 prevents or freezes the transfer of funds from the check maker account or from a network account management system (e.g., a financial institution) on behalf of the check maker account.

To illustrate, the mobile check deposit system 102 may suspend the network transaction until one or more verification processes are completed (e.g., additional check-return predictions generated or human review performed). Additionally or alternatively, the mobile check deposit system 102 may suspend the network transaction until other validation occurs—namely detecting when funds are withdrawn from the check maker account (e.g., the check posts to the check maker account). By suspending the transfer of funds to the recipient account, the mobile check deposit system 102 can avoid a risk of loss to a financial institution and/or a check maker account.

In one or more embodiments, the mobile check deposit system 102 suspends the network transaction by performing an act 322 to approve a fractional amount of a mobile check deposit amount. Specifically, the mobile check deposit system 102 approves this fractional amount of the mobile check deposit amount to issue (e.g., immediately or within a predetermined time period) to the recipient account from a financial institution on behalf of the check maker account. For instance, the mobile check deposit system 102 can approve $100 (out of a total $1300 entered for the mobile check deposit amount) for disbursement to a recipient account within one hour of initiating the mobile check deposit. In addition, the mobile check deposit system 102 suspends a remainder of the mobile check deposit amount from issuance to the recipient account until the mobile check deposit is validated (e.g., the check posts or is otherwise validated).

In one or more embodiments, the fractional amount or ratio of disbursed funds to frozen funds corresponds to the check-return prediction score 310. For example, the mobile check deposit system 102 can issue smaller fractional amounts (e.g., $20 out of $1300) for higher check-return prediction scores 310 indicating a higher probability of a check-return. By contrast, the mobile check deposit system 102 can issue larger fractional amounts (e.g., $500 out of $1300) for medium to lower check-return prediction scores 310 indicating a relatively lower probability of a check-return. In this way, the mobile check deposit system 102 can flexibly tailor a disbursement of the mobile check deposit amount based on different check-return predictions (and/or other certain features, e.g., entered amount) for a network transaction.

After suspending the network transaction, the mobile check deposit system 102 either denies the network transaction at an act 318 or approves the network transaction at an act 320. For example, at the act 318, the mobile check deposit system 102 denies the network transaction by changing the temporary suspension of the network transaction to a rejection. For example, the mobile check deposit system 102 labels the network transaction as fraudulent (or rejected check) and rejects the network transaction from issuing or completing. In one or more embodiments, the mobile check deposit system 102 saves the rejected network transaction and corresponding data for training purposes (e.g., as described below in relation to FIG. 4). Additionally, if a fractional amount was previously issued to the recipient account, the mobile check deposit system 102 can implement one or more methods to reclaim the fractional amount from the recipient account (e.g., direct withdrawal, garnishment of wages, etc.).

At the act 320, the mobile check deposit system 102 approves the network transaction in response to successful verification processes by unsuspending the network transaction. In one or more embodiments, unsuspending the network transaction allows the network transaction to issue or complete (e.g., such that funds between network accounts settle). For instance, unsuspending the network transaction allows a total entered amount for a mobile check deposit to transfer to the recipient account. Additionally, in one or more embodiments, the mobile check deposit system 102 whitelists one or more network accounts and/or similar transactions associated with a network account (e.g., to reduce or prevent future false positives).

Alternatively to suspending the network transaction at the act 312, the mobile check deposit system 102 either approves the network transaction at the act 314 or denies the network transaction at the act 316 (as described above for the acts 318-320) based on the check-return prediction score 310. For example, at the act 314, the mobile check deposit system 102 automatically approves the network transaction if the check-return prediction score is less than 0.3. As another example, the mobile check deposit system 102 automatically approves the network transaction if the check-return prediction is less than 0.35 and the entered amount is less than $100 USD. Myriad other auto-approval criteria can be implemented.

By contrast, the mobile check deposit system 102 can automatically deny the network transaction if certain criteria are met. For example, the mobile check deposit system 102 automatically denies a network transaction if the check-return prediction score is greater than or equal to 0.93 and the amount is greater than $200 USD. As another example, the mobile check deposit system 102 automatically denies a network transaction if the check-return prediction score is greater than or equal to 0.96. Myriad other auto-deny criteria can be implemented.

As mentioned above, the mobile check deposit system 102 can train the check-return machine-learning model to intelligently generate check-return predictions for network transactions. FIG. 4 illustrates the mobile check deposit system 102 training the check-return machine-learning model 308 in accordance with one or more embodiments.

As shown in FIG. 4, the mobile check deposit system 102 determines a set of training features from training features 402 corresponding to a training network transaction. In a given training iteration, the training network transaction also corresponds to a ground truth check data from ground truth check data 406. As indicated above, the training features 402 includes various features, such as check features, recipient historical account data, device data, customer-service-contact data, recipient payment schedule data, or check maker historical return/posted check data. Additionally or alternatively, the mobile check deposit system 102 identifies a set of training features corresponding to one or more training network transactions by identifying one or more features indicated in Table 1.

TABLE 1

| Feature | Description |
|---|---|
| (entered_amount) | Mobile check deposit amount |
| (maker_posted_checks_count) | # of posted checks for check maker account |
| (avg_account_balance) | Average account balance in USD |
| (posted_checks_count) | # of posted checks |
| (atm_count) | # of ATM machine uses |
| (maker_returned_checks_count) | # of returned checks for check maker account |
| (posted_checks_total_amount) | Amount, in USD, of posted checks |
| (latest_account_balance) | Account balance at last update time |
| (interchange) | # of transactions between a check maker account and a |
| | recipient account |
| (dd_count) | # of direct deposit transactions |
| (sigma_risk_score) | Sigma risk score |
| (purchase_count) | # of purchases with checks or other payment methods |
| (rejected_checks_count) | # of rejected checks (prohibited or prevented |
| | from transacting) |
| (num_disputes) | # of disputes or claims filed |
| (check_num_above_10000) | # of checks above 10,000USD |
| (dd_amount_last_30 d) | Amount, in USD, of direct deposits in last 30 days |
| (rejected_checks_total_amount) | Amount, in USD, of rejected checks |
| (ND00) | No positive or negative information reported for account |
| (dd_amount_avg) | Average amount, in USD, of direct deposit transactions |
| (dd_employers_count) | # of direct deposit transactions from one or more employers |
| (phonerisk) | Risk score based on phone number or phone interactions |
| (num_pf_transactions) | Number of peer-to-peer network transactions |
| (emailrisk) | Risk score based on email address or email correspondence |
| (recent_checks_total_amount) | Amount, in USD, of recent checks |
| (months_since_enrollment) | Time, in months, since member enrollment |
| (rejected_checks_avg_amount) | Average amount, in USD, of rejected checks |
| (addressrisk) | Risk score based on address |
| (returned_checks_avg_amount) | Average amount, in USD, of returned checks |
| (nameemailnoncorrelation) | Correlation score indicating correlation between name and |
| | email address |
| (posted_checks_avg_amount) | Average amount, in USD, of posted checks |
| (returned_checks_total_amount) | Total amount, in USD, of returned checks |
| (check_num_below_1000) | # of checks below 1,000USD |
| (dd_amount_last_15 d) | Amount, in USD, of direct deposits in last 15 days |
| (recent_checks_avg_amount) | Average amount, in USD, of recent checks |
| (returned_checks_count) | # of returned checks (checks triggering a check-return) |
| (num_disputes_last_30_days) | # of disputes or claims filed in last 30 days |
| (check_num_below_10000) | # of checks below 10,000USD |
| (recent_checks_count) | # of recent checks |
| (namephonenoncorrelation) | Correlation score indicating correlation between name and |
| | phone number |
| (_3333′) | Non-participant provider: account reported with acceptable, |
| | positive date found in current/recent transactions |
| (_1111) | Checking Account verified: account found to be open and |
| | valid checking account |
| (_5555) | Savings account verified: account found to be open and |
| | valid savings account |
| (ND01) | Routing number only valid for US Government financial |
| | institutions |
| (nameaddressnoncorrelation) | Correlation score indicating correlation between name |
| | and address |
| (check_num_below_100) | # of checks below 100USD |

In addition, the check-return machine-learning model 308 generates training check-return predictions 405 by analyzing the training features 402 corresponding to a given training network transaction. As described above, the check-return machine-learning model 308 can analyze features in a variety of different ways. For example, the check-return machine-learning model 308 comprises a plurality of decision trees as part of an XGBoost machine-learning model. Based on a given set of training features from the training features 402, the check-return machine-learning model 308 then combines a plurality of training check-return predictions (e.g., sequentially from decision trees arranged in series) to generate a particular training check-return prediction from the training check-return predictions 405.

After generating a particular training check-return prediction, the mobile check deposit system 102 evaluates the quality and accuracy of the particular training check-return prediction from the training check-return predictions 405 based on a corresponding ground truth from the ground truth check data 406. In some embodiments, the mobile check deposit system 102 generates the ground truth check data 406 in one or more different ways. In particular embodiments, the mobile check deposit system 102 generates the ground truth check data 406 utilizing a labeling approach based on historical network transactions. For instance, the mobile check deposit system 102 uses one or more of the following labels: “rejected check” indicating a check was prohibited or prevented from transacting; “duplicate check” as a particular type of rejected check that constitutes a check previously deposited; “returned check” indicating a check that triggered a check-return as defined above; or “accepted check” indicating a valid, posted check. Other suitable labels are also herein contemplated.

As further shown in FIG. 4, in a given training iteration, the mobile check deposit system 102 compares a given training check-return prediction from the training check-return predictions 405 and a corresponding ground truth from the ground truth check data 406 utilizing a loss function 408. In one or more embodiments, the loss function 408 comprises a regression loss function (e.g., a mean square error function, a quadratic loss function, an L2 loss function, a mean absolute error/L1 loss function, mean bias error). Additionally or alternatively, the loss function 408 can include a classification-type loss function (e.g., a hinge loss/multi-class SVM loss function, cross entropy loss/negative log likelihood function). In particular embodiments, the loss function 408 comprises a k-fold (e.g., 5-fold) cross-validation function.

Further, the loss function 408 can return quantifiable data regarding the difference between a given training check-return prediction from the training check-return predictions 405 and a corresponding ground truth from the ground truth check data 406. In particular, the loss function 408 can return losses 410 to the check-return machine-learning model 308 based upon which the mobile check deposit system 102 adjusts various parameters/hyperparameters. In so doing, the mobile check deposit system 102 can improve the quality/accuracy of training check-return predictions in subsequent training iterations—by narrowing the difference between training check-return predictions and ground truth check data in subsequent training iterations.

It will be appreciated that the foregoing training process is iterative and can be performed in real-time (on an on-going basis) or at predetermined batch times. For example, in certain implementations, the mobile check deposit system 102 updates the model in real time (or near-real time) as a dynamic feedback loop in response to check-return predictions generated at implementation (e.g., in production).

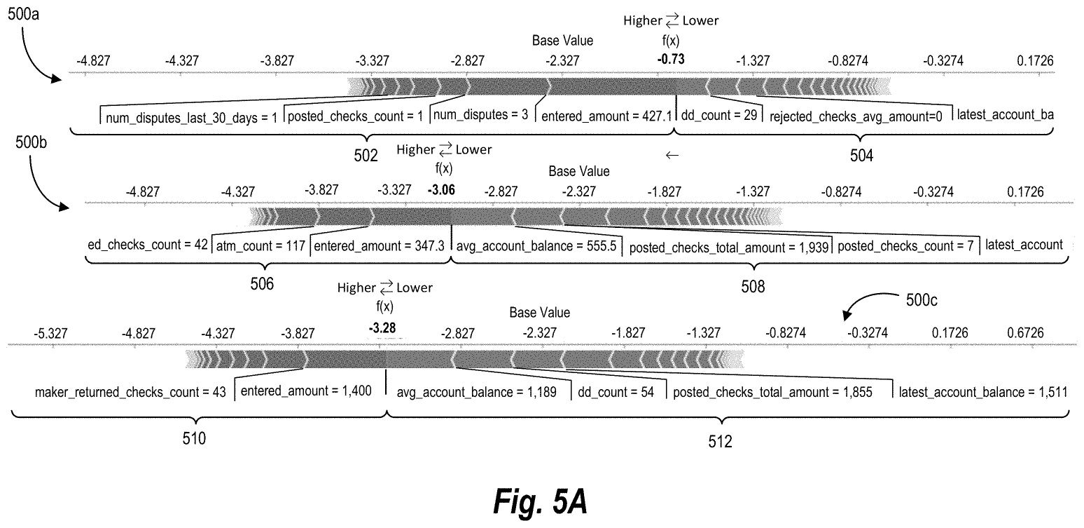

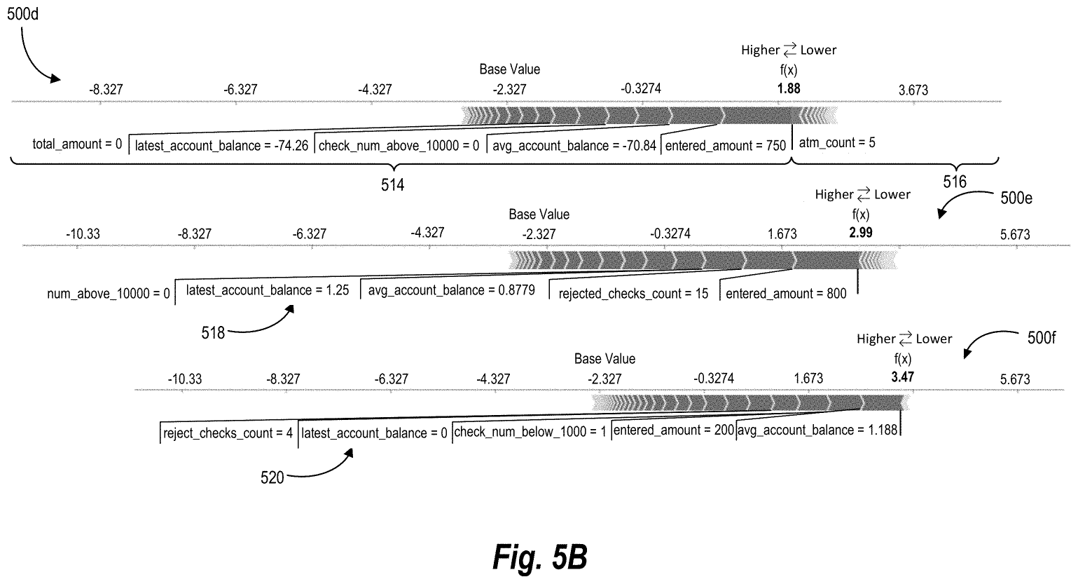

As discussed above, the mobile check deposit system 102 can generate check-return prediction scores that indicate different probability levels of fraud for a network transaction. FIGS. 5A-5B illustrate examples of different check-return prediction scores in accordance with one or more embodiments. In particular, FIG. 5A illustrates a score plot 500a for a set of features 502-504. Specifically, based on the set of features 502, 504 corresponding to a network transaction, the mobile check deposit system 102 utilizes the check-return machine-learning model 308 to generate a low-risk check-return prediction score of −1.73. For instance, the set of features 502 indicate a network transaction will likely trigger a check-return, while the set of features 504 indicate the network transaction will not likely trigger a check-return. However, the set of features 504 is greater in number (and/or is collectively associated with a greater feature importance) than the set of features 502. As a result, the check-return machine-learning model 308 generates a low-risk check-return prediction score.

FIG. 5A further illustrates score plots 500b, 500c for a set of features 506-508 and a set of features 510-512, respectively. Based on these sets of features corresponding to additional network transactions, the mobile check deposit system 102 utilizes the check-return machine-learning model 308 to generate additional low-risk check-return prediction scores of −3.06 and −3.28, respectively.

In contrast, FIG. 5B illustrates a score plot 500d for a set of features 514 and a set of features 516 for a different network transaction. Unlike FIG. 5A, however, the mobile check deposit system 102 utilizes the check-return machine-learning model 308 to generate a high-risk check-return prediction score of 1.88 based on the set of features 514 and the set of features 516. Specifically, the set of features 514 indicate a network transaction will likely trigger a check-return, while the set of features 516 indicate the network transaction will not likely trigger a check-return. However, the set of features 514 is greater in number (and/or is collectively associated with a greater feature importance) than the set of features 516. As a result, the check-return machine-learning model 308 generates a high-risk check-return prediction score.

Similarly, FIG. 5B illustrates score plots 500e, 500f for a set of features 518 and a set of features 520, respectively. Based on these sets of features corresponding to additional network transactions, the mobile check deposit system 102 utilizes the check-return machine-learning model 308 to generate additional high-risk check-return prediction scores of 2.99 and 3.47, respectively.

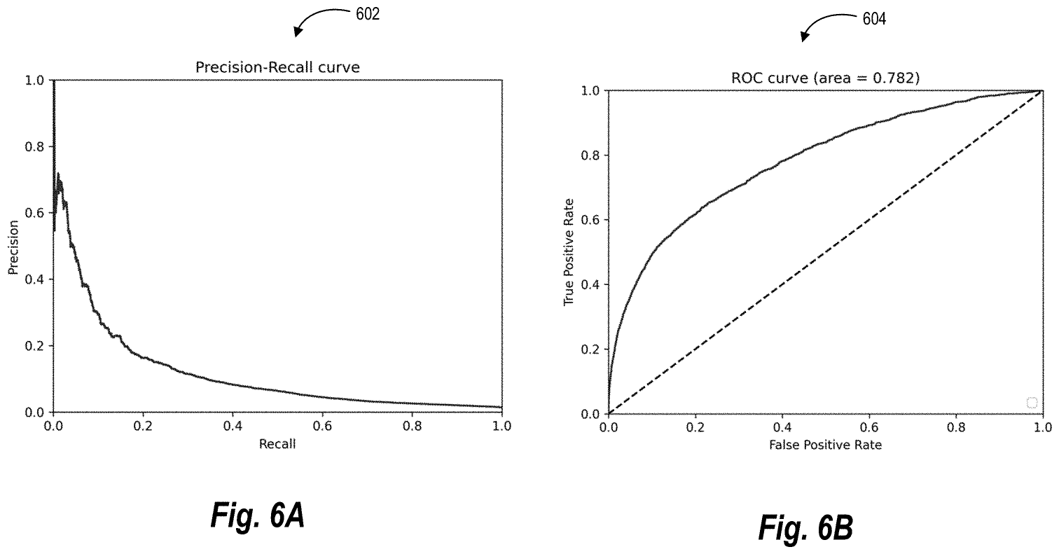

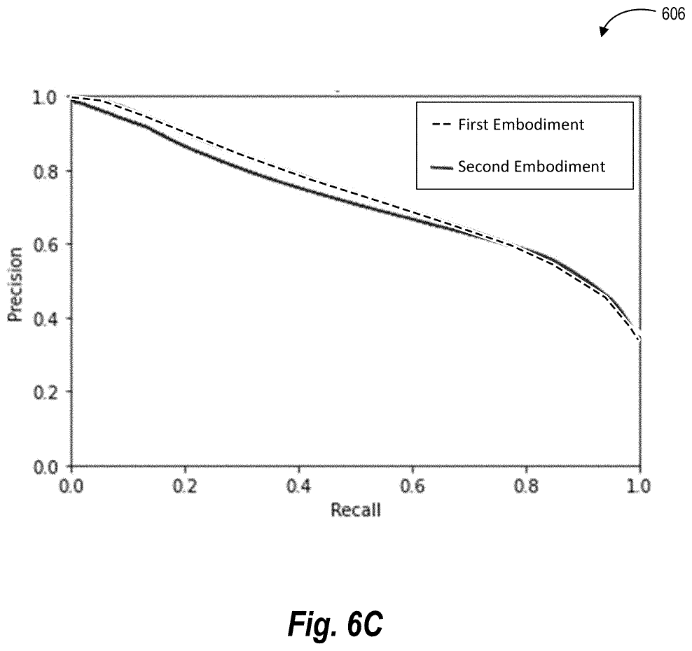

As discussed above, the mobile check deposit system 102 can efficiently and accurately generate a check-return prediction in real time (or near real time). FIGS. 6A-6C illustrate graphs of various accuracy metrics for check-return predictions by the mobile check deposit system 102 using a check-return machine-learning model in accordance with one or more embodiments. As indicated by 6A-6C, experimenters used an embodiment of the disclosed check-return machine-learning model to determine check-return predictions for a testing set of network transactions and compared the check-return predictions to a corresponding set of ground truth check data for testing. Based on the comparison of check-return predictions and corresponding ground truth check data, the experimenters determined (i) true positive rates and false positive rates for predicting mobile check deposits that trigger check-return and (ii) precision and recall for predicting mobile check deposits that trigger check-return.

In particular, FIG. 6A shows a graph 602 that indicates precision (Y-axis) versus recall (X-axis) of check-return predictions. More particularly, as indicated by FIG. 6A, the mobile check deposit system 102 uses a check-return machine-learning model that generates check-return predictions for network transactions with balanced and accurate precision and recall.

FIG. 6B shows a graph 604 indicating a true positive rate (Y-axis) versus a false positive rate (X-axis) for check-return predictions. Specifically, experimenters determined that the check-return machine-learning model provided an AUC (area under curve) score of about 78.2%. Thus, as indicated by FIG. 6B, the mobile check deposit system 102 uses a check-return machine-learning model that generates check-return predictions for network transactions with accurate true positive and false positive rates.

It will be appreciated that training the check-return machine-learning model utilizing different training features can affect (e.g., improve) accuracy of check-return predictions. For example, FIG. 6C shows a graph 606 indicating the precision-recall curves for first and second embodiments of the check-return machine-learning model generating check-return predictions. These first and second embodiments, albeit different from each other, both implement the “rejected check” label as an additional positive label to improve model accuracy in certain implementations. Accordingly, the mobile check deposit system 102 can implement a variety of different training data to flexibly increase check-return prediction accuracy.

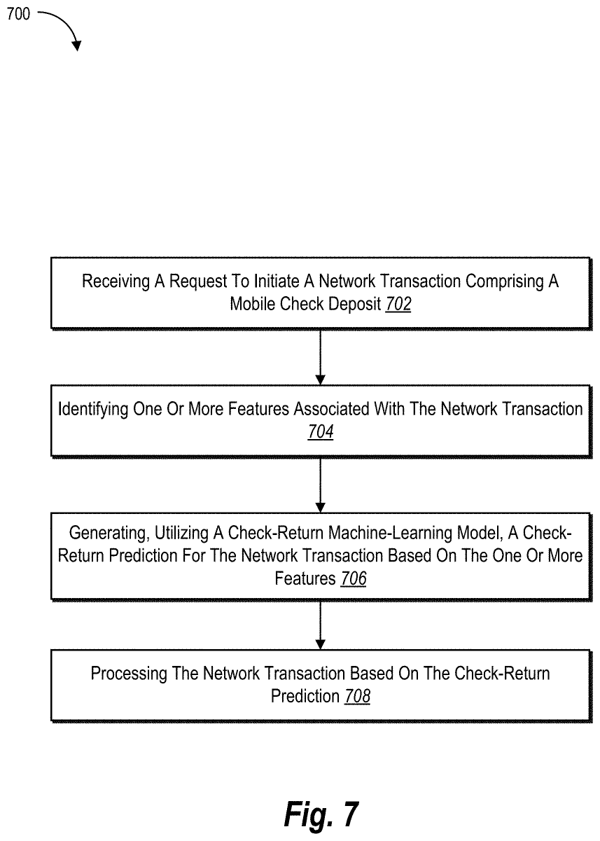

FIGS. 1-6C, the corresponding text, and the examples provide several different systems, methods, techniques, components, and/or devices of the mobile check deposit system 102 in accordance with one or more embodiments. In addition to the above description, one or more embodiments can also be described in terms of flowcharts including acts for accomplishing a particular result. For example, FIG. 7 illustrates a flowchart of a series of acts 700 utilizing a check-return machine-learning model to generate a check-return prediction for a network transaction in accordance with one or more embodiments. The mobile check deposit system 102 may perform one or more acts of the series of acts 700 in addition to or alternatively to one or more acts described in conjunction with other figures. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

As shown in FIG. 7, the series of acts 700 includes an act 702 of receiving a request to initiate a network transaction comprising a mobile check deposit.

In addition, the series of acts 700 includes an act 704 of identifying one or more features associated with the network transaction. In some embodiments, identifying the one or more features associated with the network transaction comprises identifying at least one of: check features, historical returned and posted checks for a check maker account, recipient account historical data, or recipient account payment schedule data.

The series of acts 700 further includes an act 706 of generating, utilizing a check-return machine-learning model, a check-return prediction for the network transaction based on the one or more features. In some embodiments, generating the check-return prediction comprises: weighting the one or more features in at least two decision trees arranged in series; generating a first check-return prediction utilizing a first decision tree; and generating a second check-return prediction utilizing a second decision tree based on the first check-return prediction. In certain implementations, generating the check-return prediction comprises generating a check-return prediction score.

Additionally, the series of acts 700 includes an act 708 of processing the network transaction based on the check-return prediction. In some embodiments, processing the network transaction based on the check-return prediction comprises approving the network transaction, suspending the network transaction, or denying the network transaction. In certain implementations, suspending the network transaction comprises: approving, for account issuance, a fractional amount of a mobile check deposit amount; and suspending, from account issuance, a remainder of the mobile check deposit amount until the mobile check deposit is validated.

Further, in some embodiments, the act 708 comprises processing the network transaction by: approving the network transaction based on the check-return prediction score satisfying a first threshold check-return prediction score; suspending the network transaction based on the check-return prediction score satisfying a second threshold check-return prediction score; or denying the network transaction based on the check-return prediction score satisfying a third threshold check-return prediction score.

It is understood that the outlined acts in the series of acts 700 are only provided as examples, and some of the acts may be optional, combined into fewer acts, or expanded into additional acts without detracting from the essence of the disclosed embodiments. Additionally, the series of acts 700 described herein may be repeated or performed in parallel with one another or in parallel with different instances of the same or similar acts. As an example of an additional act not shown in FIG. 7, act(s) in the series of acts 700 may include an act of: generating, within a memory device, a data structure comprising features associated with prior network transactions and network account data for a plurality of network accounts; and in response to receiving the request to initiate the network transaction, accessing the data structure within the memory device to identify the one or more features associated with the network transaction.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 (e.g., the server(s) 106, the client device(s) 110a-110n, the administrator device 114, and/or the third-party server(s) 118) that may be configured to perform one or more of the processes described above. As shown by FIG. 8, the computing device can comprise a processor 802, memory 804, a storage device 806, an I/O interface 808, and a communication interface 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, storage device 806 can comprise a non-transitory storage medium described above. The storage device 806 may include a hard disk drive (“HDD”), flash memory, a Universal Serial Bus (“USB”) drive or a combination of these or other storage devices.

The computing device 800 also includes one or more input or output interface 808 (or “I/O interface 808”), which are provided to allow a user (e.g., requester or provider) to provide input to (such as user strokes), receive output from, and otherwise transfer data to and from the computing device 800. The I/O interface 808 may include a mouse, keypad or a keyboard, a touch screen, camera, optical scanner, network interface, modem, other known I/O devices or a combination of such I/O interface 808. The touch screen may be activated with a stylus or a finger.

The I/O interface 808 may include one or more devices for presenting output to a user, including, but not limited to, a graphics engine, a display (e.g., a display screen), one or more output providers (e.g., display providers), one or more audio speakers, and one or more audio providers. In certain embodiments, interface 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device and one or more other computing devices 800 or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include a bus 812. The bus 812 can comprise hardware, software, or both that connects components of computing device 800 to each other.

FIG. 9 illustrates an example network environment 900 of the inter-network facilitation system 104. The network environment 900 includes a client device 906 (e.g., client device 110a-110n), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation systems 104, third-party systems 908, and networks 904, this disclosure contemplates any suitable number of client devices 906, inter-network facilitation system 104, third-party systems 908, and networks 904. As an example, and not by way of limitation, network environment 900 may include multiple client device 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, mobile check deposit system 102, and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 8. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party-system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt into or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A non-transitory computer-readable medium comprising instructions that, when executed by at least one processor, cause a computing device to:
train a check-return machine-learning model using one or more training features corresponding to a training network transactions, wherein training the check-return machine-learning model comprises comparing a training check-return prediction to ground truth check data using a loss function to generate losses that are used to adjust one or more parameters of the check-return machine-learning model;
receive a request to initiate a network transaction comprising a mobile check deposit;
identify one or more features associated with the network transaction;
generate, utilizing the trained check-return machine-learning model, a check-return prediction for the network transaction based on the one or more features; and
process the network transaction based on the check-return prediction.

2. The non-transitory computer-readable medium of claim 1, further comprising instructions that, when executed by the at least one processor, cause the computing device to identify the one or more features associated with the network transaction by identifying at least one of: check features, historical returned and posted checks for a check maker account, recipient account historical data, or recipient account payment schedule data.

3. The non-transitory computer-readable medium of claim 1, further comprising instructions that, when executed by the at least one processor, cause the computing device to generate the check-return prediction by:
weighting the one or more features in at least two decision trees arranged in series;
generating a first check-return prediction utilizing a first decision tree; and
generating a second check-return prediction utilizing a second decision tree based on the first check-return prediction.

4. The non-transitory computer-readable medium of claim 1, further comprising instructions that, when executed by the at least one processor, cause the computing device to process the network transaction based on the check-return prediction by approving the network transaction, suspending the network transaction, or denying the network transaction.

5. The non-transitory computer-readable medium of claim 4, further comprising instructions that, when executed by the at least one processor, cause the computing device to suspend the network transaction by:
approving, for account issuance, a fractional amount of a mobile check deposit amount; and
suspending, from account issuance, a remainder of the mobile check deposit amount until the mobile check deposit is validated.

6. The non-transitory computer-readable medium of claim 1, further comprising instructions that, when executed by the at least one processor, cause the computing device to:
generate the check-return prediction by generating a check-return prediction score; and
process the network transaction by:
approving the network transaction based on the check-return prediction score satisfying a first threshold check-return prediction score;
suspending the network transaction based on the check-return prediction score satisfying a second threshold check-return prediction score; or
denying the network transaction based on the check-return prediction score satisfying a third threshold check-return prediction score.

7. The non-transitory computer-readable medium of claim 1, further comprising instructions that, when executed by the at least one processor, cause the computing device to:
generate, within a memory device, a data structure comprising features associated with prior network transactions and network account data for a plurality of network accounts; and
in response to receiving the request to initiate the network transaction, access the data structure within the memory device to identify the one or more features associated with the network transaction.

8. A system comprising:
at least one processor; and
at least one non-transitory computer-readable storage medium comprising instructions that, when executed by the at least one processor, cause the system to:
train a check-return machine-learning model using one or more training features corresponding to training network transactions, wherein training the check-return machine-learning model comprises comparing a training check-return prediction to ground truth check data using a loss function to generate losses that are used to adjust one or more parameters of the check-return machine-learning model;
receive a request to initiate a network transaction comprising a mobile check deposit;
identify one or more features associated with the network transaction;
generate, utilizing the trained check-return machine-learning model, a check-return prediction for the network transaction based on the one or more features; and
process the network transaction based on the check-return prediction.

9. The system of claim 8, further comprising instructions that, when executed by the at least one processor, cause the system to identify the one or more features associated with the network transaction by identifying at least one of: check features, historical returned and posted checks for a check maker account, recipient account historical data, or recipient account payment schedule data.

10. The system of claim 8, further comprising instructions that, when executed by the at least one processor, cause the system to generate the check-return prediction by:
weighting the one or more features in at least two decision trees arranged in series;
generating a first check-return prediction utilizing a first decision tree; and
generating a second check-return prediction utilizing a second decision tree based on the first check-return prediction.

11. The system of claim 8, further comprising instructions that, when executed by the at least one processor, cause the system to process the network transaction based on the check-return prediction by approving the network transaction, suspending the network transaction, or denying the network transaction.

12. The system of claim 11, further comprising instructions that, when executed by the at least one processor, cause the system to suspend the network transaction by:
approving, for account issuance, a fractional amount of a mobile check deposit amount; and
suspending, from account issuance, a remainder of the mobile check deposit amount until the mobile check deposit is validated.

13. The system of claim 8, further comprising instructions that, when executed by the at least one processor, cause the system to:
generate the check-return prediction by generating a check-return prediction score; and
process the network transaction by:
approving the network transaction based on the check-return prediction score satisfying a first threshold check-return prediction score;
suspending the network transaction based on the check-return prediction score satisfying a second threshold check-return prediction score; or
denying the network transaction based on the check-return prediction score satisfying a third threshold check-return prediction score.

14. The system of claim 8, further comprising instructions that, when executed by the at least one processor, cause the system to:
generate, within a memory device, a data structure comprising features associated with prior network transactions and network account data for a plurality of network accounts; and
in response to receiving the request to initiate the network transaction, access the data structure within the memory device to identify the one or more features associated with the network transaction.

15. A computer-implemented method comprising:
training a check-return machine-learning model using one or more training features corresponding to training network transactions, wherein training the check-return machine-learning model comprises comparing a training check-return prediction to ground truth check data using a loss function to generate losses that are used to adjust one or more parameters of the check-return machine-learning model;
receiving, by a computing device, a request to initiate a network transaction comprising a mobile check deposit;
identifying, by the computing device, one or more features associated with the network transaction;
generating, utilizing the trained check-return machine-learning model, a check-return prediction for the network transaction based on the one or more features; and
processing the network transaction based on the check-return prediction.

16. The computer-implemented method of claim 15, wherein identifying the one or more features associated with the network transaction comprises identifying at least one of: check features, historical returned and posted checks for a check maker account, recipient account historical data, or recipient account payment schedule data.

17. The computer-implemented method of claim 15, wherein generating the check-return prediction comprises:
weighting the one or more features in at least two decision trees arranged in series;
generating a first check-return prediction utilizing a first decision tree; and
generating a second check-return prediction utilizing a second decision tree based on the first check-return prediction.

18. The computer-implemented method of claim 15, wherein processing the network transaction based on the check-return prediction comprises approving the network transaction, suspending the network transaction, or denying the network transaction.

19. The computer-implemented method of claim 18, wherein suspending the network transaction comprises:
approving, for account issuance, a fractional amount of a mobile check deposit amount; and
suspending, from account issuance, a remainder of the mobile check deposit amount until the mobile check deposit is validated.

20. The computer-implemented method of claim 15, wherein:
generating the check-return prediction comprises generating a check-return prediction score; and
processing the network transaction comprises:
approving the network transaction based on the check-return prediction score satisfying a first threshold check-return prediction score;
suspending the network transaction based on the check-return prediction score satisfying a second threshold check-return prediction score; or
denying the network transaction based on the check-return prediction score satisfying a third threshold check-return prediction score.
